(19) United States
(12) Patent Application Publication
(10) Pub. No.: US 2005/0046187 A1
(43) Pub. Date: Mar. 3, 2005

(54) Pipe joint for refrigeration cycle having combination of O-ring and backup ring

(76) Inventors: Masayuki Takeuchi, Nukata-gun (JP); Yoshitaka Tomatsu, Chiryu-city (JP); Osamu Shioume, Kasugai-city (JP)

Correspondence Address: HARNESS, DICKEY & PIERCE, P.L.C., P.O. BOX 828, BLOOMFIELD HILLS, MI, 48303, US

(21) Appl. No.: 10/899,732

(22) Filed: Jul. 27, 2004

(30) Foreign Application Priority Data
Jul. 29, 2003 (JP) 2003-282075

(51) Int. Cl. F16L 17/00

(52) U.S. Cl. 285/348; 285/347

(57) ABSTRACT

A pipe joint for the refrigeration cycle is disclosed. A female joint (20) has a fitting recess (24), and a male join (10) has a fitting protrusion (14) and a stepped portion (13). In the male joint (10) and the female joint (20), a backup ring (30) and an O-ring (31) are fitted adjacently to each other in the stepped portion. The fitting protrusion (14), the backup ring (30) and the O-ring (31) are fitted in a fitting recess (24). The O-ring (31) is formed of an elastic material having a high blister resistance to carbon dioxide refrigerant. The backup ring (30) is formed of a resin material having a smaller permeability coefficient than the O-ring (31) against the carbon dioxide refrigerant and plastically deformable under the pressure of the refrigerant imposed on the O-ring (31). The refrigerant leakage amount can thus be minimized.

### BACKGROUND OF THE INVENTION

1. Field of the Invention

The present invention relates to a pipe joint used to connect refrigerant pipes to each other in a refrigeration cycle or, in particular, to a structure for hermetically connecting an atmospheric side and a refrigerant side through two hermetic sealing-members.

2. Description of the Related Art

A conventional pipe joint of this type for the refrigeration cycle, which comprises a male joint 100 and a female joint 110 for connecting the refrigerant pipes, as shown in FIG. 7A, is available.

The female joint 110 includes a fitting recess 111 cylindrically formed on the inner periphery thereof. The male joint 100 includes a fitting protrusion 101 formed cylindrically and a stepped portion 102 formed adjacently to the fitting protrusion 101 and having a smaller outer diameter than the fitting protrusion 101. An O-ring 120 constituting a second hermetic sealing-member arranged in the direction communicating with the refrigerant side and a backup ring 130 constituting a first hermetic sealing-member arranged in the direction communicating with the atmosphere side are adjacently fitted in the stepped portion 102. The outer periphery of the fitting protrusion 101, the O-ring 120 and the backup ring 130 is fitted in the fitting recess 111 thereby to hermetically seal the atmosphere side and the refrigerant side.

The backup ring 130 is a hermetic sealing-ring for preventing the displacement (sticking-out) of the O-ring 120 and formed by bias cutting of a PTFE (polytetrafluoroethylene) material. The backup ring 130 is arranged with a first end surface thereof pressed against the pressure-fitting wall portion 103 formed on the male joint 100.

As a result, with the refrigerant pressure imparted from the refrigerant side to a first end surface of the O-ring 120 adjacent to the backup ring 130, the first end surface of the backup ring 130 is pressed against the pressure-fitting wall portion 103 and plastically deformed, thereby filling the gap between the fitting recess 111 and the fitting protrusion 101. In this way, the O-ring is prevented from being displaced toward the low-pressure side while, at the same time, securing to hermetically seal the refrigerant side and the atmosphere side (See JIS (Japanese Industrial Standard) B2407: Backup ring for O-ring).

In the supercritical refrigeration cycle using carbon dioxide refrigerant, however, a rubber material or a resin material, when in contact with or immersed in the carbon dioxide refrigerant in the supercritical state, has been found to have a higher permeability than with the conventional flon or substitute flon refrigerant.

In the configuration described above, the backup ring 130 formed of PTFE (polytetrafluoroethylene) resin material has a comparatively high permeability coefficient to carbon dioxide refrigerant in supercritical state. As shown in FIG. 7B, therefore, the problem is posed that the carbon dioxide refrigerant leaks to the atmosphere side through the O-ring 120 and the backup ring 130 due to the refrigerant pressure. Further, as the backup ring 130 is formed by bias cutting, the problem of the refrigerant leaking from the bias cut surface occurs in spite of a high mountability.

### SUMMARY OF THE INVENTION

In view of the points described above, it is an object of the present invention to provide a pipe joint for a refrigeration cycle in which the first hermetic sealing-member leading to the atmosphere side is formed of a plastic material less permeable to a carbon dioxide refrigerant thereby to minimize refrigerant leakage.

The above-mentioned object is achieved by employing technical means according to first to fifth aspects of the invention.

Specifically, according to a first aspect of the invention, there is provided a pipe joint for connecting refrigerant pipes in a refrigeration cycle, comprising a male joint (10) and a female joint (20),
wherein the female joint (20) includes a fitting recess (24) formed cylindrically on an inner periphery thereof,
wherein the male joint (10) includes a cylindrically formed fitting protrusion (14) and a stepped portion (13) formed at the forward end of the fitting protrusion (14) and having an outer diameter smaller than the fitting protrusion (14).,
wherein the male joint (10) and the female joint (20) are such that a first hermetic sealing-member (30), with a first end surface thereof arranged in the direction communicating with the atmosphere and a second hermetic sealing-member (31) with the other end surface thereof arranged in the direction communicating with the refrigerant are fitted adjacently to each other in the stepped portion (13),
wherein the outer peripheral portions of the fitting protrusion (14), the first hermetic sealing-member (30) and the second hermetic sealing-member (31) are fitted in the fitting recess (24) thereby to secure hermetically sealing the refrigerant side and the atmosphere side, and
wherein the second hermetic sealing-member (31) is formed of an elastic material having a high blister resistance against the carbon dioxide refrigerant, and the first hermetic sealing-member (30) has the function of a backup ring and a smaller permeability coefficient to carbon dioxide refrigerant than the second hermetic sealing-member (31), the first hermetic sealing-member (30) being formed of a resin material adapted to be plastically deformed under the pressure of the refrigerant side imposed on the second hermetic sealing-member (31).

The first hermetic sealing-member (30) is formed as an endless ring having a cross section in the shape of a substantial rectangle, a substantial polygon or a substantial semicircle.

The male joint (10) includes a pressure-fitting wall portion (12) in pressure contact with the first end surface of the first hermetic sealing-member (30) fitted in the stepped portion (13). The first hermetic sealing-member (30) has a cross section of a substantial rectangle, a substantial polygon or a substantial semicircle and formed in such a shape that the contact area of the first end surface pressed against the pressure-fitting wall portion (12) is larger than the contact area of the other end surface contacted by the second hermetic sealing-member (31).

In the first aspect of the invention, the first hermetic sealing-member (30) arranged in the direction communicating with the atmosphere side is formed of a plastically deformable resin material having a smaller permeability coefficient than the second hermetic sealing-member (31) of an elastic material. Thus, the permeability coefficient to carbon dioxide refrigerant in the supercritical state can be reduced considerably as compared with the conventional material of PTFE (polytetrafluoroethylene). As a result, the amount of the refrigerant leaking through the first hermetic sealing-member (30) and the second hermetic sealing-member (31) can be minimized.

Further, as the first hermetic sealing-member (30) is formed of a plastically deformable resin material, the gap generated between the fitting recess (24) and the first hermetic sealing-member (30) can be positively filled due to the refrigerant pressure from the second hermetic sealing-member (31) for an improved hermeticity.

As compared with the conventional bias cut structure, the first hermetic sealing-member (30) is formed as an endless ring without seams, and therefore the refrigerant leakage which otherwise might be caused through the seams can be eliminated.

As the contact area with the pressure-fitting wall portion (12) is reduced, the stress on the first end surface is increased, thereby improving the hermeticity in the boundary surface with the pressure-fitting wall portion (12).

According to a second aspect of the invention, there is provided a pipe joint for the refrigeration cycle, wherein the first hermetic sealing-member (30) is formed of a resin material having a thermal deformation temperature of preferably about 60 degrees or lower in accordance with Rule A of JIS (Japanese Industrial Standard) K7191-2.

According to a third aspect of the invention, there is provided a pipe joint for the refrigeration cycle, wherein the first hermetic sealing-member (30) has an outer diameter preferably about 1.0 to 1.03 times as large as the inner diameter of the fitting recess (24).

According to a fourth aspect of the invention, there is provided a pipe joint for the refrigeration cycle, wherein the first hermetic sealing-member (30) is formed of selected one of PA11 (nylon 11), PA12 (nylon 12) and HDPE (high-density polyethylene). In the fourth aspect of the invention, the second hermetic sealing-member (31) is formed of an elastic material, such as IIR, H-NBR or EPDM, which is high in blister resistance against carbon dioxide refrigerant. Nevertheless, the former materials have a permeability coefficient to carbon dioxide refrigerant, and smaller than the latter materials, and, therefore, the refrigerant leakage due to the permeation can be considerably reduced as compared to a conventional PTFE (polytetrafluoroethylene) material.

According to a fifth aspect of the invention, there is provided a pipe joint for the refrigeration cycle, wherein the refrigeration cycle is the supercritical refrigeration cycle using the carbon dioxide refrigerant. In the fifth aspect of the invention, the resin material having a small permeability coefficient is preferably used for the supercritical refrigeration cycle.

The reference numerals inserted in the parentheses attached to each of the means described above designate the correspondence with the specific means in embodiments described later.

The present invention may be more fully understood from the description of the preferred embodiments of the invention set forth below, together with the accompanying drawings.

### BRIEF DESCRIPTION OF THE DRAWINGS

In the drawings:

FIG. 1A is a longitudinal sectional view showing a general configuration of a pipe joint for the refrigeration cycle according to a first embodiment of the invention.

FIG. 1B is an exploded view showing a general configuration of a pipe joint for the refrigeration cycle according to the first embodiment.

FIG. 2 is an enlarged view of the part A shown in FIG. 1A.

FIG. 3 is a diagram for explaining the manner in which the refrigerant permeates through the O-ring 31 and the backup ring 30 according to the first embodiment of the invention.

FIG. 4 is a characteristic diagram showing the relation between the material and the refrigerant leakage amount in various combinations of the O-ring 31 and the backup ring 30.

FIG. 5 is a characteristic diagram showing the relation between the material and the refrigerant leakage amount in various combinations of the O-ring 31 formed of IIR and the backup ring 30.

FIG. 6A is a longitudinal sectional view of the backup ring 30 according to a second embodiment of the invention.

FIG. 6B is a longitudinal sectional view of the backup ring 30 according to a second embodiment of the invention.

FIG. 6C is a longitudinal sectional view of the backup ring 30 according to a second embodiment of the invention.

FIG. 6D is a longitudinal sectional view of the backup ring 30 according to a second embodiment of the invention.

FIG. 7A is a longitudinal sectional view showing a general configuration of the conventional pipe joint for the refrigeration cycle.

FIG. 7B is an enlarged view of the part A shown in FIG. 7A.

### DESCRIPTION OF THE PREFERRED EMBODIMENTS

(First Embodiment)

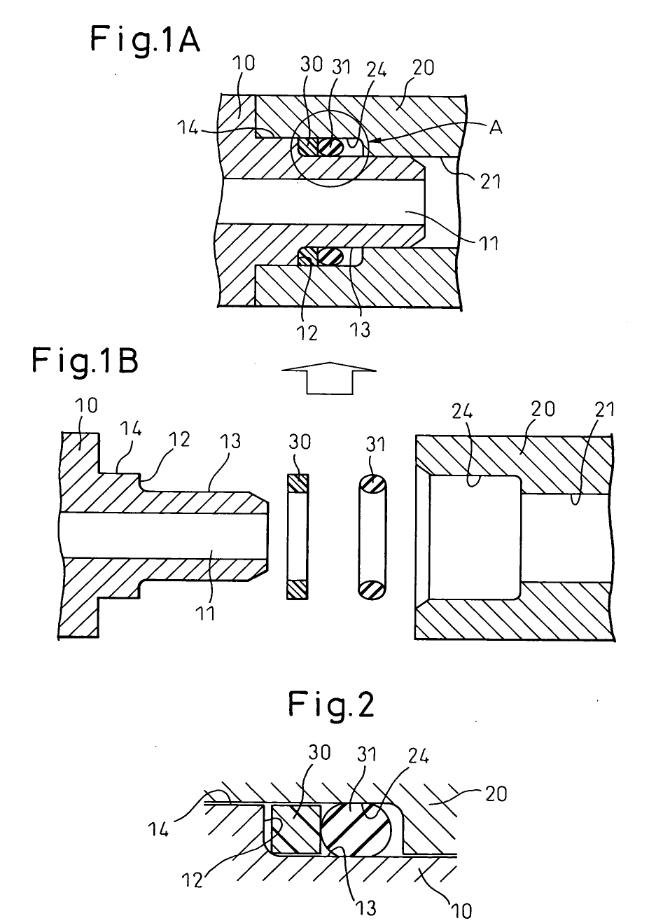

A pipe joint for the refrigeration cycle according to a first embodiment of the invention is explained below with reference to FIGS. 1 to 5. FIG. 1 shows an example of the application of this invention to a pipe joint by which the refrigerant pipes for the refrigerant cycle using the carbon dioxide refrigerant are connected coaxially.

This pipe joint, as shown in FIGS. 1A and 1B, comprises a male joint 10 and a female joint 20. The female joint 20 has one end open and the other end connected with refrigerant pipe not shown. A cylindrically shaped refrigerant path 21 and a fitting recess 24 are formed on the inner periphery of the female joint 20.

The male joint 10 includes a fitting protrusion 14 formed cylindrically at an end thereof, and a stepped portion 13 cylindrically formed and extending toward the forward end from the fitting protrusion 14. The inner periphery of the male joint 10 is formed with a refrigerant path 11, and the other end of the male joint 10 is connected with the refrigerant pipe not shown. The stepped portion 13 has a smaller outer diameter than the fitting protrusion 14. The part of the stepped portion 13 nearer to the fitting protrusion 14 is formed with a pressure-fitting wall portion 12 against which a first end surface of the first hermetic sealing-member 30, described later, is pressed.

A backup ring 30 making up the first hermetic sealing-member arranged in the direction communicating with the atmosphere side and an O-ring 31 constituting the second hermetic sealing-member arranged on the refrigerant side are fitted adjacently to each other on the stepped portion 13. The outer periphery of the fitting protrusion 14, the backup ring 30 and the O-ring 31 is fitted in the fitting recess 24 of the female joint 20 thereby to attain hermeticity between the refrigerant side and the atmosphere side. The male joint 10 and the female joint 20 are coupled to each other by a fastening member such as a bolt not shown.

The O-ring 31 arranged in the direction communicating with the refrigerant side is formed of a hermetic sealing-member of an elastic material such as rubber or, especially, a selected one of IIR, H-NBR and EPDM having a high blister resistance hardly affected by bubbles generated by contact with, or immersion in, carbon dioxide in supercritical state (the state in which the liquid and the gas assume a single phase).

The backup ring 30 arranged in the direction communicating with the atmosphere side, on the other hand, is a hermetic sealing-member to prevent the O-ring 31, described above, from being deformed under the refrigerant pressure and displaced (stuck out) toward the atmosphere side. As shown in FIG. 2, the backup ring 30 is formed of an annular resin material having a substantially rectangular cross section. Specifically, the backup ring 30 is formed of a resin material such as PA11 (nylon 11), PA12 (nylon 12) or HDPE (high-density polyethylene) having a smaller permeability coefficient to carbon dioxide (CO₂) than IIR, H-NBR or EPDM of the O-ring 31 described above.

The research conducted by the inventors shows that the rubber and resin materials described above including EPDM, H-NBR (acrylonitrile-butadiene rubber with a mid-high value of the coupling acrylonitrile amount), PTFE (polytetrafluoroethylene), IIR and PA12 (nylon 12) have a descending order of the permeability coefficient to carbon dioxide. PA11 (nylon 11), PA12 (nylon 12) and HDPE (high-density polyethylene) are formed of a crystalline resin material having a dense molecular structure and, therefore, have superior characteristics as gas barriers.

The backup ring 30 is required to be formed of a resin material plastically deformable to prevent the displacement of the O-ring 31. Specifically, this material is required to behave in such a manner that with the refrigerant pressure imparted to a first end surface of the O-ring 31 from the refrigerant side, the first end surface of the backup ring 30 is pressed against the pressure-fitting wall portion 12 while at the same time being plastically deformed and widened along the inner and outer diameters thereof, thereby filling the gap between the fitting recess 24 and the backup ring 30.

According to this embodiment, the material described above is formed to have a characteristic in which the thermal deformation temperature thereof is preferably about 60 degrees or lower. The thermal deformation temperature characteristic is determined based on Rule A of JIS K7191-2. As long as the refrigerant pressure imparted to the first end surface of the O-ring 31 is, for example, 1.80 MPa or higher, the backup ring 30 is plastically deformed and can fill the gap. On the other hand, the backup ring 30 has an outer diameter slightly larger than the outer diameter of the O-ring 31, and about 1.0 to 1.03 times as large as the inner diameter of the fitting recess 24.

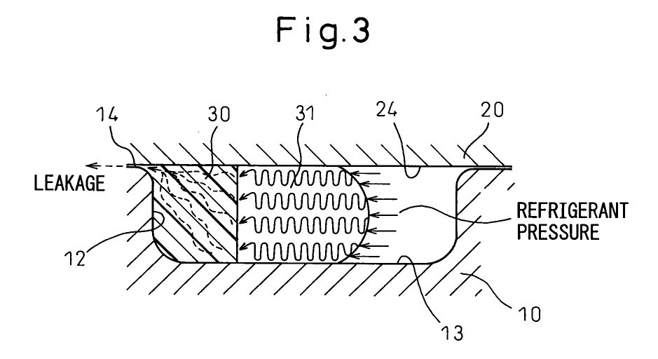

Next, the operation of the pipe joint for the refrigeration cycle having the aforementioned configuration is explained with reference to FIG. 3. FIG. 3 is a diagram for explaining the manner in which the carbon dioxide refrigerant on the refrigerant side permeates through the O-ring 31 and the backup ring 30. With the refrigerant pressure of the refrigerant side imparted to the first end surface of the O-ring 31, the carbon dioxide refrigerant permeating through the O-ring 31 permeates to a lesser amount, through the backup ring 30, thereby causing leakage to the atmosphere side. By employing a material having a smaller permeability coefficient for the backup ring 30 than for the O-ring 31, however, the refrigerant leakage can be suppressed much more than in the conventional pipe joint formed of PTFE (polytetrafluoroethylene) material.

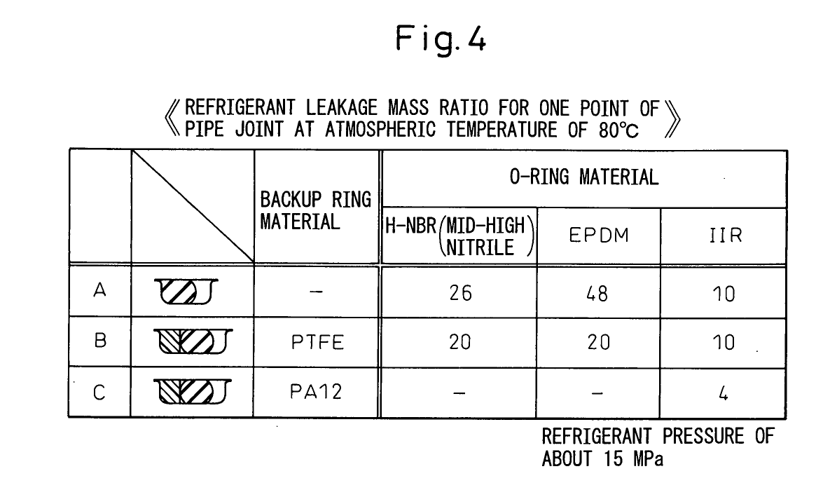

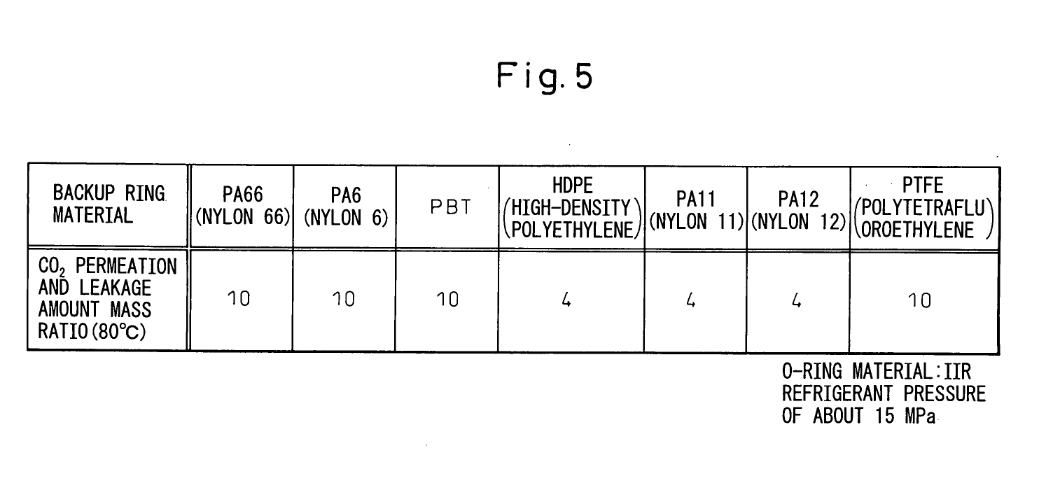

The relation between the materials of the O-ring 31 and the backup ring 30 and the refrigerant leakage amount has been experimentally confirmed and will be explained with reference to FIGS. 4 and 5. FIG. 4 shows measurements of the mass ratio of the refrigerant leakage for each point of the pipe joint under the refrigerant pressure of about 15 MPa at the ambient temperature of 80° C. that are exhibited by the combinations of three types of rubber material of the O-ring 31 including H-NBR (mid-high nitrile), EPDM and IIR on the one hand and resin materials of the backup ring 30 including PTFE (polytetrafluoroethylene) and PA12 (nylon 12) on the other hand.

In step A shown in FIG. 4, only the O-ring 31 is arranged on the stepped portion 13, while in step B, the backup ring 30 formed of the conventional material of PTFE (polytetrafluoroethylene) is arranged, and in step C, PA12 (nylon 12) according to the invention is used. This comparison shows that the refrigerant leakage amount is smallest for the combination of PA12 (nylon 12) and IIR in step C.

FIG. 5 shows a comparison of the refrigerant leakage mass ratio of seven types of resin material of the backup ring 30 including PA66, PA6, PBT, HDPE (high-density polyethylene), PA11 (nylon 11), PA12 (nylon 12) and PTFE (polytetrafluoroethylene) with the material of the O-ring 31 fixed to IIR. This comparison shows that PA11 (nylon 11), PA12 (nylon 12) and HDPE (high-density polyethylene) are preferable and lowest in refrigerant leakage amount.

As the result of checking the refrigerant leakage amount in a similar way by selecting and combining materials of the backup ring 30 hard to develop plastic deformation with the O-ring 31 of IIR, it has also been found that the characteristics obtained from these combinations are inferior to those obtained by the combinations above.

With the pipe joint for the refrigeration cycle according to the first embodiment, a plastically deformable resin material smaller in permeability coefficient than the O-ring 31 of an elastic material like rubber is employed in forming the backup ring 30 arranged in the direction communicating with the atmosphere side, and therefore the permeability coefficient to carbon dioxide refrigerant in supercritical state can be remarkably reduced as compared with the conventional pipe joint of PTFE (polytetrafluoroethylene), thereby making it possible to minimize the refrigerant leakage through the backup ring 30 and the O-ring 31.

Further, since the backup ring 30 is formed of a plastically deformable resin material, the gap formed between the fitting recess 24 and the backup ring 30 can be positively filled due to the refrigerant pressure from the O-ring 31 for an improved hermeticity.

Also, in view of the fact that the conventional bias cutting is replaced by an endless ring having seams less than those of the bias-cutting, the refrigerant leakage which otherwise might occur from the seams can be eliminated.

The backup ring 30 is formed of a resin material having a thermal deformation temperature of preferably about 60° C. or lower according to Rule A of JIS K7191-2, and therefore is easily plastically deformed under the pressure of the refrigerant side. As a result, the gap formed between the fitting recess 24 and the backup ring 30 can be positively filled under the refrigerant pressure from the O-ring 31 for an improved hermeticity. Incidentally, a resin material hardly deformed plastically has been found to be inferior in hermeticity.

The backup ring 30 has a larger outer diameter than the O-ring 31. Therefore, the hermeticity is achieved positively on the one hand and the displacement of the O-ring 31 to the low pressure side can be accurately prevented on the other hand. Further, in view of the fact that the outer diameter of the backup ring 30 is preferably 1.0 to 1.03 times as large as the inner diameter of the fitting recess 24, a high mountability in the fitting recess 24 is secured.

Specifically, the backup ring 30 is formed of a selected one of PA11 (nylon 11), PA12 (nylon 12) and HDPE (high-density polyethylene). The backup ring 30 formed of any of these materials is combined with the O-ring 31 of, for example, IIR as an elastic material having a high blister resistance against the carbon dioxide refrigerant. Thus, the refrigerant leakage due to the permeability can be remarkably reduced as compared with the conventional material of PTFE (polytetrafluoroethylene). Also, these materials are preferably used for the supercritical refrigeration cycle with the carbon dioxide refrigerant.

(Second Embodiment)

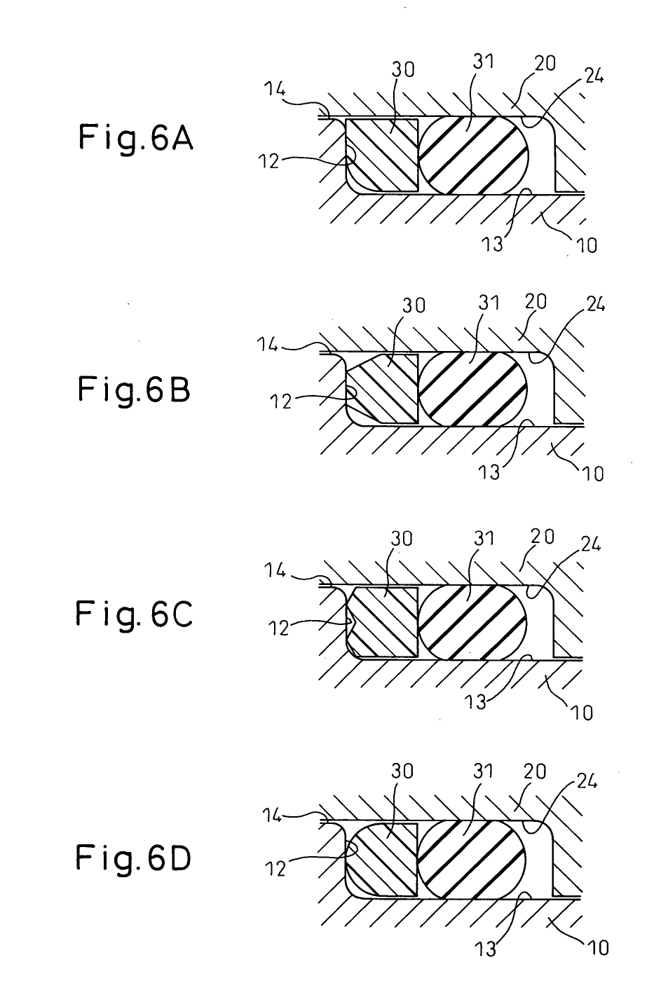

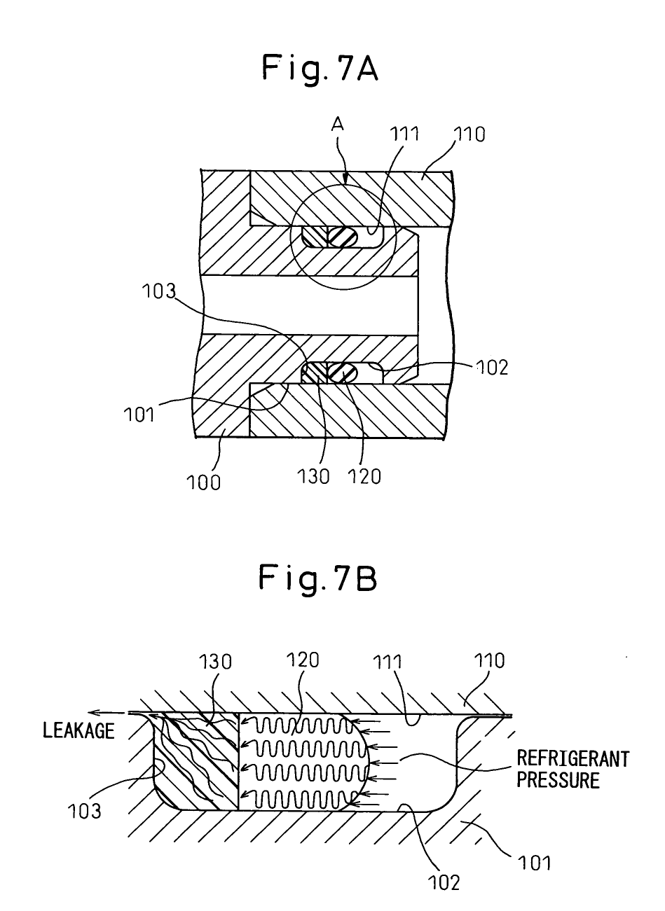

According to the first embodiment described above, the backup ring 30 has a substantially rectangular cross section. Alternatively, instead of the substantially rectangular cross section, the cross section of the backup ring 30 may be substantially polygonal or substantially semicircular as shown in FIG. 6. Specifically, FIG. 6A shows the backup ring 30 with a round form on only one corner of the rectangular section thereof in line with the round form of the pressure-fitting wall portion 12. With this configuration, as in a substantially rectangular form, the backup ring 30 is pressed against the pressure-fitting wall portion 12 and is plastically deformed while being widened along the inner and outer diameters thereof under the refrigerant pressure, thereby filling the gap.

In FIG. 6B, the backup ring 30 is formed as a substantial polygon with a trapezoidal first end surface thereof in such a manner that the contact area of the first end surface pressed against the pressure-fitting wall portion 12 is smaller than the contact area of the other end surface in contact with the O-ring 31. According to this configuration, the reduced contact area with the pressure-fitting wall portion 12 can increase the stress at the first end surface, thereby improving the hermeticity of the boundary with the pressure-fitting wall portion 12.

FIG. 6C shows a configuration in which the backup ring 30 is formed with a crest and a bottom on the first end surface thereof thereby to reduce the contact area with the pressure-fitting wall portion 12. This configuration has similar effects to the configuration shown in FIG. 6B. In FIG. 6D, on the other hand, the first end surface of the backup ring 30 is formed as a semicircle to a reduce the contact area with the pressure-fitting wall portion 12. This configuration has similar effects to the configurations shown in FIGS. 6B and 6C.

(Other Embodiments)

Specific numerical values included in the embodiments are only examples to which this invention is not limited.

While the invention has been described by reference to specific embodiments chosen for the purposes of illustration, it should be apparent that numerous modifications could be made thereto by those skilled in the art without departing from the basic concept and scope of the invention.

1. A pipe joint comprising a male joint and a female joint for connecting refrigerant pipes used in a refrigeration cycle,
wherein said female joint included a fitting recess cylindrically formed on an inner periphery thereof,
wherein said male joint includes a fitting protrusion formed cylindrically and a stepped portion arranged on the forward end side of said fitting protrusion and having an outer diameter smaller than said fitting protrusion,
wherein said male joint and said female joint are so configured that a first hermetic sealing-member with a first end surface thereof arranged in the direction communicating with the atmosphere side and a second hermetic sealing-member with the other end surface thereof arranged in the direction communicating with the refrigerant side are adjacently fitted on said stepped portion, and
outer peripheral sides of said fitting protrusion, said first hermetic sealing-member and said second hermetic sealing-member are fitted in said fitting recess thereby to hermetically seal the refrigerant side and the atmosphere side,
wherein said second hermetic sealing-member is formed of an elastic material having a high blister resistance against carbon dioxide refrigerant,
wherein said first hermetic sealing-member has the function of a backup ring and a smaller permeability coefficient to carbon dioxide refrigerant than that of said second hermetic sealing-member, said first hermetic sealing-member being formed of a resin material plastically deformable under the pressure of the refrigerant side imposed on said second hermetic sealing-member,
wherein said first hermetic sealing-member is formed as an endless ring having a cross section in the shape of a substantial rectangle, a substantial polygon or a substantial semicircle,
wherein said male joint includes a pressure-fitting wall portion against which the first end surface of said first hermetic sealing-member fitted on said stepped portion is pressed, and
wherein said first hermetic sealing-member has a cross section in the shape of a substantial rectangle, a substantial polygon or a substantial semicircle in such a manner that the contact area of the first end surface pressed against said pressure-fitting wall portion is smaller than the contact area of the other end surface contacted by said second hermetic sealing-member.

2. A pipe joint for the refrigeration cycle according to claim 1,
wherein said first hermetic sealing-member is formed of a resin material with the thermal deformation temperature thereof preferably not higher than about 60° C. under Rule A of JIS K7191-2.

3. A pipe joint for the refrigeration cycle according to claim 1,
wherein said first hermetic sealing-member has an outer diameter preferably about 1.0 to 1.03 times as large as the inner diameter of said fitting recess.

4. A pipe joint for the refrigeration cycle according to claim 1,
wherein said first hermetic sealing-member is formed of selected one of materials including PA11 (nylon 11), PA12 (nylon 12) and HDPE (high-density polyethylene).

5. A pipe joint for the refrigeration cycle according to claim 1,
wherein said refrigeration cycle is a supercritical refrigeration cycle using carbon dioxide refrigerant.
